(19) United States
(12) Patent Application Publication
(10) Pub. No.: US 2024/0269495 A1
(43) Pub. Date: Aug. 15, 2024

(54) SAFETY EQUIPMENT

(71) Applicant: Skanska UK PLC, Rickmansworth (GB)

(72) Inventors: Richard KENNEDY, Rickmansworth (GB); Alex HOYOS, Rickmansworth (GB)

(21) Appl. No.: 18/620,145

(22) Filed: Mar. 28, 2024

Related U.S. Application Data
(62) Division of application No. 16/417,067, filed on May 20, 2019, now Pat. No. 11,969,612.
Application No. 16/417,067 is a continuation of application No. 14/439,611, filed on Apr. 29, 2015, now abandoned.

(30) Foreign Application Priority Data
Nov. 1, 2012 (GB) 1219688.7

(51) Int. Cl. A62B 35/00; F16B 45/02

(52) U.S. Cl. CPC A62B 35/0075; F16B 45/023; F16B 45/028

(57) ABSTRACT

A method of providing a safety system includes: (a) providing a first rope or lanyard to which a first attached safety hook is attached; (b) retrofitting a first load detection sensor to the first safety hook without altering the structural integrity of the first safety hook by mounting the first load detection sensor on or shrink wrapped on the first safety hook; (c) detecting a load by the first load detection sensor; (d) generating a load status signal by the first load detection sensor in response to the detecting of the load; and (e) via a transmitter arranged to receive the load status signal from the first load detection sensor, receiving the load status signal from the first load detection sensor and transmitting the load status signal therefrom.

### CROSS-REFERENCE TO RELATED APPLICATIONS

This is a divisional of U.S. patent application Ser. No. 16/417,067, filed on May 20, 2019, which is a continuation of U.S. patent application Ser. No. 14/439,611, filed on Apr. 29, 2015, which is a National Stage Entry into the United States Patent and Trademark Office from International PCT Patent Application No. PCT/GB2013/000462, having an international filing date of Oct. 30, 2013, and which claims priority to United Kingdom Patent Application No. GB 1219688.7, filed Nov. 1, 2012, the entire contents of all of which are incorporated herein by reference.

### FIELD OF THE INVENTION

The present invention relates to retrofitable safety equipment for use with safety systems. In particular, but not exclusively, the present invention relates to safety equipment for use with construction safety systems.

### DESCRIPTION OF RELATED ART

According to the UK's Health and Safety Executive (HSE) construction falls from height are the biggest cause of fatal injury in the nation's workplaces; further, they represent roughly 50% of work-related deaths in the construction sector. In addition, over 4,000 major injuries, such as broken bones or fractured skulls, are reported to HSE each year by the construction industry and around 50% of these serious injuries relate to or are caused by falls from height. Although safety equipment such as safety belts, hooks and security lines have been in use in the industry for years, in practice, a high proportion of workers carry out their work while the safety equipment is disconnected. Both HSE and employers in the industry have taken steps to improve observance of safety regulations and to prevent deaths and injuries from falls; for example HSE has implemented heavy fines which are levied on contractors if personnel are found to be using safety equipment incorrectly on a site. However, on large building projects it is very difficult to monitor workers continuously to ensure that they always adhere to safety rules and practice.

However, the construction industry continues to cause more deaths than any other industrial sector. Consequently, safety systems which allow usage of safety equipment to be monitored have been proposed. For example, EP2314354 describes a safety system and a safety belt comprising a connecting member, a rope, an attaching portion, a hook, and a load detection portion arranged to detect whether or not a load is applied to the connecting member and to generate a load detection signal which is sent to a control device including a receiver unit arranged to receive the load detection signal and a notification unit arranged to provide a warning or alarm. In this system, the control unit determines the status of a user or the status of the safety belt based on the load detection signal and the notification unit provides a visible or audible alarm if a load is detected or if the safety belt is disconnected.

The disadvantage of the system proposed by EP2314354 and other known systems is that the components described therein are not standard and are therefore every expensive to manufacture. Moreover, the components have not been subject to the rigorous functional and structural testing necessary for approval in jurisdictions such as the European Union and the US; as a result, it is unknown whether the hooks and lines described in EP2314354 are able to withstand the stresses borne by standard hooks or karabiners and standard lines. Further, safety equipment for use in the European construction industry must comply with IP65, that is, equipment must be totally protected against dust ingress and must also be protected against high pressure water jets from any direction.

### SUMMARY OF THE INVENTION

The present invention therefore aims to provide a safety system which complies with security and ingress protection standards, composition and structural standards and which is cheaper to manufacture than prior art systems.

According to the present invention, a method is provided that includes the steps of: (a) providing a first rope or lanyard to which a first attached safety hook is attached; (b) retrofitting a first load detection sensor to the first safety hook without altering the structural integrity of the first safety hook by mounting the first load detection sensor on or shrink wrapped on the first safety hook; (c) detecting a load by the first load detection sensor; (d) generating a load status signal by the first load detection sensor in response to the detecting of the load; and (e) via a transmitter arranged to receive the load status signal from the first load detection sensor, receiving the load status signal from the first load detection sensor and transmitting the load status signal therefrom.

It is contemplated that this method may include the additional steps of determining, at a first time, if the load status signal is greater than 0 N; and, if no load is detected at the first time, generating a signal that the first safety hook is not hooked.

Still further, the method may include the steps of: determining, at a second time, if the load status signal is less than 5 N; and, if a load is detected at the second time that is less than 5 N, generating a signal that the first safety hook is hooked.

Next, the method may include the steps of: determining, at a third time, if the load status is greater than 5 N; and, if a load is detected at the third time that is greater than 5 N, generating a signal indicating that a user associated with the first safety hook has fallen.

The steps at the first time, the second time, and the third time may be performed independently of one another and/or serially.

Next, the method also may include the steps of: (f) providing a second rope or lanyard to which a second attached safety hook is attached; (g) retrofitting a second load detection sensor to the second safety hook without altering the structural integrity of the second safety hook by mounting the second load detection sensor on or shrink wrapped on the second safety hook; (h) detecting a load by the second load detection sensor; (i) generating a load status signal by the second load detection sensor in response to the detecting of the load; (j) via a transmitter arranged to receive the load status signal from the second load detection sensor, receiving the load status signal from the second load detection sensor and transmitting the load status signal therefrom.

Here, it is contemplated that the method may include the steps of: determining, at a first time, if the load status signal is greater than 0 N; and, if no load is detected at the first time, generating a signal that the second safety hook is not hooked.

Still further, the method may include the steps of: determining, at a second time, if the load status signal is less than 5 N; and, if a load is detected at the second time that is less than 5 N, generating a signal that the second safety hook is hooked.

In addition, the method may include the steps of: determining, at a third time, if the load status is greater than 5 N; and, if a load is detected at the third time that is greater than 5 N, generating a signal indicating that a user associated with the second safety hook has fallen.

The steps at the first time, the second time, and the third time may be performed independently of one another and/or serially.

The present invention also provides for a method of operating a safety system that includes (a) a first rope or lanyard, (b) a first safety hook attached to the first rope or lanyard, (c) a first load detection sensor retrofit on the first safety hook without altering the structural integrity of the first safety hook by being mounted on or shrink wrapped on the first safety hook, wherein the first load detection sensor generates a load status signal, and (d) a first transmitter arranged to receive the load status signal from the first load detection sensor and to transmit the load status signal therefrom. Here, the method includes: determining, at a first time, if the load status signal is greater than 0 N; if no load is detected at the first time, generating a signal that first safety hook is not hooked; determining, at a second time, if the load status signal is less than 5 N; if a load is detected at the second time that is less than 5 N, generating a signal that the first safety is hooked; determining, at a third time, if the load status is greater than 5 N; and, if a load is detected at the third time that is greater than 5 N, generating a signal indicating that a user associated with the first safety hook has fallen.

This method also may include (e) a second rope or lanyard, (f) a second safety hook attached to the second rope or lanyard, (g) a second load detection sensor retrofit on the second safety hook without altering the structural integrity of the second safety hook by being mounted on or shrink wrapped on the second safety hook, wherein the second load detection sensor generates a load status signal, and (h) a second transmitter arranged to receive the load status signal from the second load detection sensor and to transmit the load status signal therefrom. If so, the method is contemplated to include: determining, at a first time, if the load status signal is greater than 0 N; if no load is detected at the first time, generating a signal that second safety hook is not hooked; determining, at a second time, if the load status signal is less than 5 N; if a load is detected at the second time that is less than 5 N, generating a signal that the second safety is hooked; determining, at a third time, if the load status is greater than 5 N; and, if a load is detected at the third time that is greater than 5 N, generating a signal indicating that a user associated with the second safety hook has fallen.

Still other aspects of the present invention will be made apparent from the discussion that follows and from the drawings appended hereto.

### BRIEF DESCRIPTION OF THE DRAWINGS

Preferred embodiments of the present invention will now be described, by way of example only, with reference to the accompanying drawings in which:

FIG. 1 shows a safety hook having a load detection sensor in accordance with a first embodiment of the present invention;

FIG. 2 shows a safety hook having a load detection sensor in accordance with a second embodiment of the present invention;

FIG. 3a shows a safety hook having a load detection sensor in accordance with a third embodiment of the present invention;

FIG. 3b shows the safety hook of FIG. 3a in use;

FIG. 4 shows processing means in accordance with an embodiment of the present invention;

FIG. 5 shows processing means in accordance with another embodiment of the present invention; and

FIG. 6 is a diagrammatic representation of a computerised security system for displaying at a monitoring station the status of four workers each having a safety hook having a load detection sensor and processing means in accordance with the present invention;

FIG. 7 is a block diagram illustration of example logic steps followed by processing means according to the present invention, and

FIG. 8 is a block diagram illustration of example logic steps followed by a pair of load detection sensor connected to the processing means of FIGS. 4, 5, 6 and 7 above.

### DETAILED DESCRIPTION OF EMBODIMENT(S) OF THE INVENTION

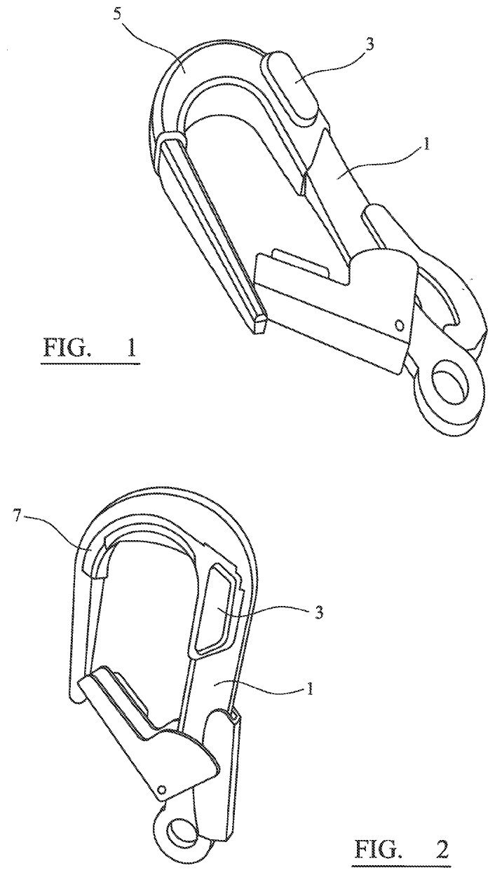

Referring now to FIG. 1 there is shown a safety hook 1 according to a first embodiment of the present invention. The safety hook 1 has an upper section which has been retrofitted with a load detection sensor 5 formed by a layer of shrinkable polymer plastics material (such as polyolefin) incorporating, coated or impregnated with quantum tunnelling composite materials, such as QTC®. This type of composite material is a mixture of conductive filler particles (such as highly-conductive metals) and elastomeric binders (for example silicone rubber) which use quantum tunnelling for pressure switching and sensing. Quantum tunnelling composite materials have the ability to change from an electrical insulator to a conductor when placed under pressure so that when pressure is absent the atoms of the conductive metals are too distant to conduct electricity but when pressure is applied, the conductive atoms congregate and electrons conduct electricity through the composite. Accordingly, these materials can be used to detect even very small changes due to compression, tension or other stresses. In the present invention, the load detection sensor 5 is able to detect a pressure change caused by a load being applied on the hook.

The load detection sensor 5 described above can be shrunk onto a standard hook 1 such as a karabiner, ascender, descender, fall arrester, crane hook and scaffold hook by simply applying heat with a heat gun, or any method suitable to shrink-wrap the upper section of the hook. A transmitter 3 is connected to or included in the load detection sensor. In use, the load detection sensor 5 perceives the pressure change generated by attaching the hook 1 to a rope or a lanyard and generates a first load status signal which is sent by the transmitter 3 to a receiver operably connected to processing means. The processing means analyses the load status signal and allows warning means to generate a notification or signal, for example a visible green light, to indicate that the hook is fastened. In the event the pressure changes again because a heavier load, such as one produced by a fall from a scaffold, is applied, the load detection sensor 5 generates a second load status signal. When the second load status signal is analysed by the processing means, a second notification, for example an audible alarm is generated by the warning means to enable the user and those around him to identify that a heavy load is being applied on the hook.

Referring now to FIG. 2 there is shown a safety hook 1 comprising a load detection sensor 7 according to a second embodiment of the present invention. In this embodiment, the load detection sensor is a piezoelectric sensor arranged to generate an electrical signal or electrical charge in response to pressure change. The load detection sensor 7 is mounted on a rigid plate which has been adhered to a standard safety hook 1. A transmitter 3 is also mounted on the plate. In use, the safety system of this embodiment works in the same way as that described in relation to the safety system of the first embodiment.

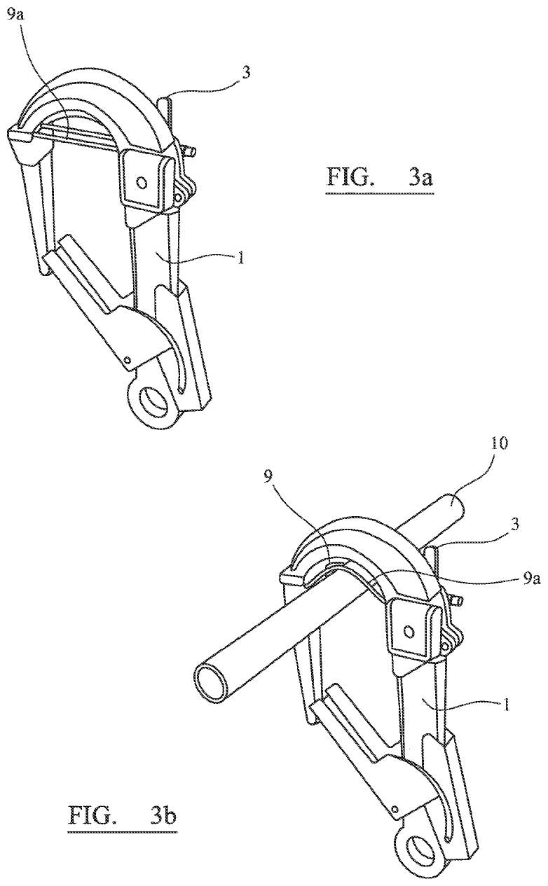

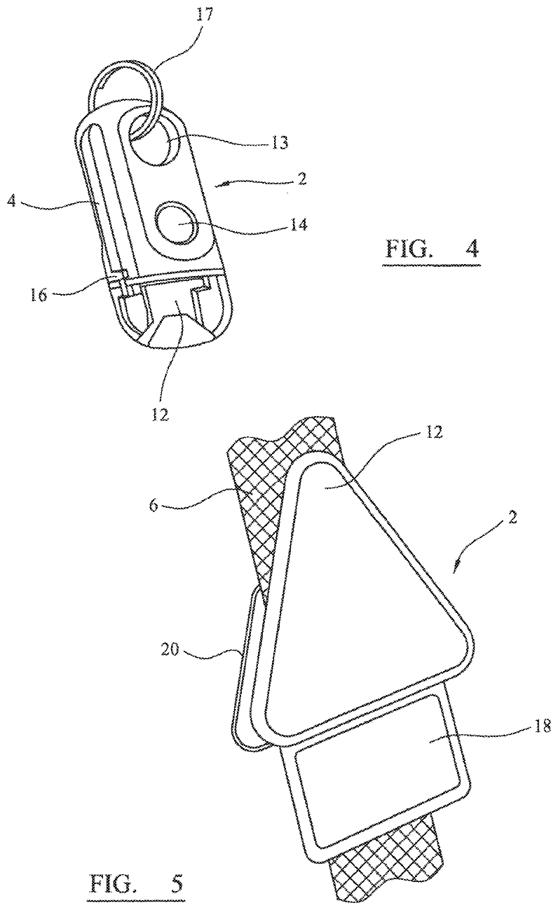

Referring now to FIGS. 3a and 3b, there is shown a load detection sensor 9 according to a third embodiment of the present invention. In this particular embodiment, the load detection sensor 9 comprises a first and second self-energising switches mounted on a rigid plate which rigid plate is adhered to a standard safety hook 1, each self-energising switch being operably connected to a steel cable 9a. A transmitter 3 arranged to relay a load status signal is also mounted on the rigid plate. In use, the first self-energising switch is arranged to be activated when the steel cable 9a is pulled so that when the safety hook 1 is connected to a line 10, the first switch is activated and generates a load detection signal which is relayed by the transmitter 3 to processing means. Whereas, the second self-energising switch is arranged to be activated when the steel cable 9a is in a relaxed condition so that when the steel cable 9a is relaxed, the second self-energising switch is activated and a second load detection signal is relayed by the transmitter to the processing means.

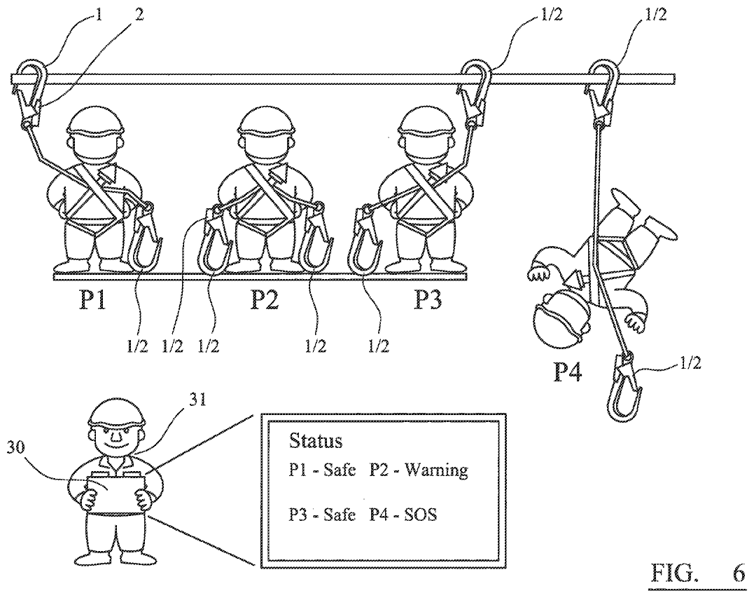

FIG. 4 shows a processing unit or beacon 4 including processing means 2, the beacon 4 having an activation switch or other activation means 14, and an opening 13 for receiving a metallic ring 17 which allows the beacon to be secured to a standard harness. Warning means 12, in this instance a super bright LED, is secured to an end of the beacon 4. In addition zip ties 16 are provided for securing the beacon 4 to items, such as clothing, which do not have a suitable opening 13. As described above in relation to FIG. 1, processing means 2 is operably connected to a receiver which receives a load status signal from a transmitter 3. Processing means are arranged to analyse the load detection signal from a load detection sensor 5, 7, 9 and to produce an output signal and to control the warning means so that a range of notifications or signals are generated to indicate whether the safety hook 1 is connected to a safety line and/or whether a load greater than a predetermined threshold is applied to the load detection sensor 5, 7, 9. A beacon 4 according to this embodiment of the present invention can be used with any of the load detection sensors 5, 7, 9 described in relation to FIGS. 1, 2, 3a and 3b. The beacon 4 is powered with standard batteries, such as AA batteries. In this particular embodiment, the beacon 4 comprises an activation switch 14 and a counter arranged to allow a user to activate the beacon 4 from a non-operational state to an operational state by pressing the activation switch. Once the beacon 4 has become operational, the counter measures a predetermined time interval, for example 3 months, and sends a time lapse signal to the processing means 2 once the predetermined time interval has elapsed. In this embodiment, the processing means 2 are further arranged to analyse the time lapse signal and to produce a time output signal which time output signal causes the warning means to generate a time elapsed alarm, either visible, audible or both, to notify a user that the life-span of batteries has elapsed. The processing means monitors the batteries and also produces a time output signal if it detects that there is insufficient power left, i.e. that the batteries are running low so that the warning means generates a time elapsed alarm, either visible, audible or both, to alert the user that the batteries must be replaced. A three month time interval is particularly useful because safety equipment is generally inspected every three months and, in general, batteries would be expected to have a useful life of around 3 months. The counter can be adapted to reset once the batteries have been replaced and the activation switch 14 has been pressed.

Referring now to FIG. 5, there is shown a second type of processing unit. In this embodiment, the processing means 2 are housed in a processing unit comprising a super bright LED 12 and a metallic back plate 20 for securing the processing unit to a standard harness 6. As above, the processing unit is powered by batteries and may include a counter. Display means 18 are secured to the processing unit to enable an equipment inspector to mark the processing unit with an inspection message including for example, date, time, and initials or name of the last check.

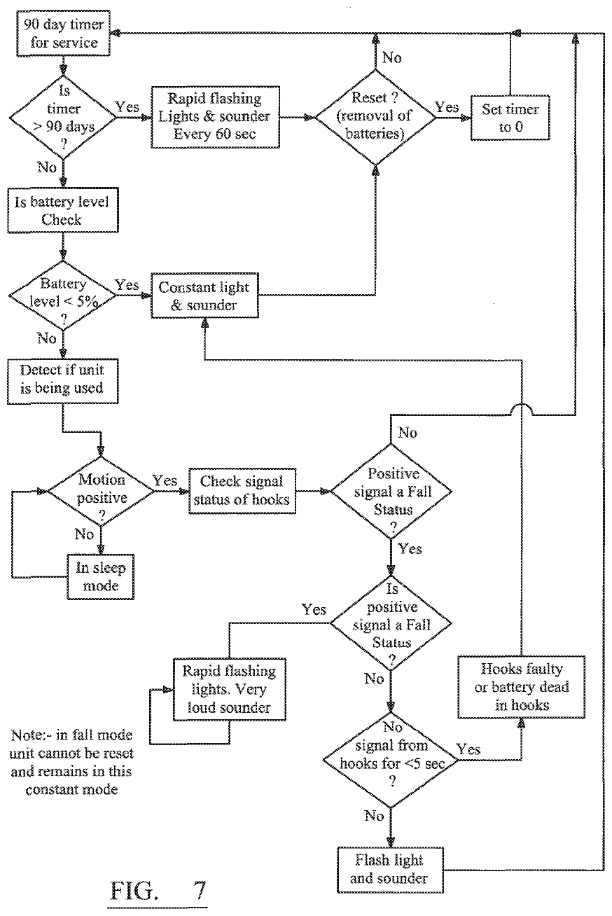

Referring now to FIG. 6 there is shown a scheme of a further embodiment of the present invention in which the processing means 2 are arranged to communicate wirelessly with a monitoring device 30, such as an on-site computer, to allow a supervisor 31, for example a site manager, to remotely monitor use of the safety equipment. As illustrated, four site workers P1 to P4 are shown, each wearing two safety hooks 1 and/or processing means 2 each tagged with an ID so that the supervisor 31 remotely monitoring use of the safety equipment can determine whether any specific users on the site are appropriately secured to a safety line. As shown, workers P1 and P3 are correctly hooked up with their second hook secured to their harness and the appropriate signal is sent remotely to the monitoring device 30 where the status of these two workers is indicated as “Safe”. Worker P2 is not hooked up and a warning signal is sent remotely to the monitoring device 30. The processing means 2 preferably includes a radio link to enable the supervisor to speak directly to the worker to check where the worker is and whether he/she should be hooked up or not, even though the employee may not be visible to the supervisor. Worker P4 is illustrated as having fallen which generates an emergency signal which is sent directly to the supervisor who can immediately identify the worker and implement SOS procedures. Thus, if there is an accident on-site, the supervisor is immediately and remotely alerted to facilitate a prompt and appropriate response. In this embodiment, the processing means need not be housed in a processing unit and could be housed in the safety hook 1, for example. Further, in this embodiment, the warning means may be remotely connected to the processing means. The main purpose of the second hook is to enable workers to move position and to clip on the second hook in a new position, before removing the first hook. In this way the worker is always clipped in position.

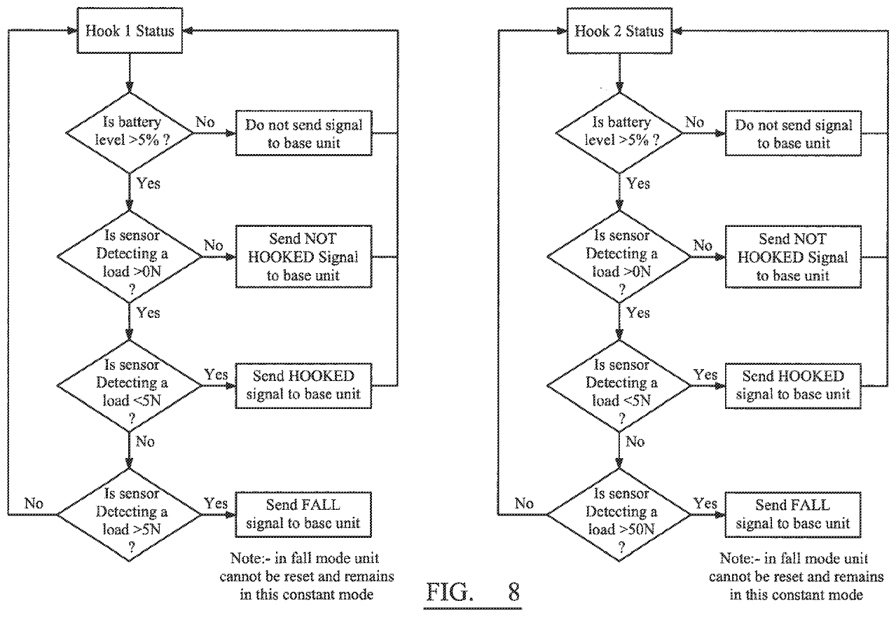

FIG. 7 shows block diagram illustration the logic steps followed by processing means 2 according to the present invention. As seen in FIG. 7, the system is provided with a day counter. In a first step, the system establishes whether the counter has measured over 90 day (i.e. 3 months) of service. If the answer is yes, the processing unit causes the system to generate, for example, a flashing light and a sound to enable a user to remove the batteries from the processing unit to reset the system and, as a result, the counter is reset to zero. If the answer to the first step is no, the processing unit determines whether the battery level is under 5%. If the battery level is below 5%, the processing means cause the system to generate a constant light and a sound to alert a user that the battery is low. If the battery level is above 5%, the processing means proceeds to the next step in which the processing means determines if the system is being used. If the system in in sleep mode, the processing unit follows repeats the step in a loop until it detects motion. On the other hand, if motion is detected, the processing means proceeds to the following step in which it checks whether a signal from the hook or hooks has been received. If no signals are detected, the processing means loops back to the first step in a loop and follows each subsequent step. If a positive signal from the hook or hooks is detected, the processing unit proceeds to determine whether the signal relates to a fall status. In the event the signal is related to a fall, the processing means causes the system to generate flashing lights and a loud audible alarm to alert on-site personnel that a user is in danger. To ensure safety of the users, the system could be set up to prevent a reset when a fall signal has been detected. mode. If the signal does not relate to a fall, the processing unit proceeds to determine whether the signal is constant or intermittent. If the signal has an interval of over 5 seconds, the processing means assumes that the hook or hooks are faulty or that the battery level is under 5% and causes the system to generate a constant light and a sound. If the interval between two instances of detection of a signal is below 5 seconds, the processing means causes the system to produce a flashing light and a sound to alert on-site personnel that the user might be in danger.

Referring now to FIG. 8, there is shown block diagram illustration the logic steps followed by a pair of load detection sensors 5, 7, 9 connected to the processing means described in relation to FIGS. 4, 5, 6 and 7 above. Each sensor follows the same logic steps simultaneously. In a first step, the processing unit determines whether the battery level is over 5%. If the battery level is under 5%, the processing unit does not receive a signal from the hook. If the battery level is over 5%, the processing means proceeds to determine whether the hook sensor detects a load over ON. If no load is detected, the processing means causes the system to generate a signal to alert the system that the user is not hooked. If a load is detected, the processing means determine whether the load is under 5 N. If the load detected by the hook sensor is below 5 N, the processing means causes the system to generate a signal to indicate that the user is hooked. If the load detected is not under 5 N, the processing means determines whether the load exceeds 5 N. If the load detected does not exceed 5 N, the logic loops back to the first step. However, if the load detected by the hook sensor exceeds 5 N, the processing means causes the system to generate a FALL signal to alert on-site personnel that the user has suffered a fall. As the system shown in this figure comprises a pair of hooks, the processing means may be set up to generate an visual or audible alarm when either hook sensor detects a fall (i.e. a load which exceeds 5 N). In addition, the processing means may be programmed to generate an alarm when it detects that neither hook is connected to a line.

A transmitter 3 suitable for use with any of the embodiments of the present invention comprises a 433 MHz PCB antenna.

One of the main advantages of the present system, and in particular of the embodiment described in relation to FIG. 6, is that a supervisor can monitor whether any given user is employing safety equipment appropriately at any given time so that on-site personnel are encouraged to adhere to safety regulations and to use safety equipment. Moreover, it would allow evaluating personnel safety equipment history so that individual users found to systematically disregard safety regulations can be disciplined. Further, it would also allow a supervisor to monitor safety equipment use remotely so that regardless of the size of the site or project, a supervisor would always know if personnel are connected to a line and if an accident has occurred.

As mentioned one of the greatest advantages of the present invention is that it can be used with standard equipment such as harnesses, lanyards, hooks, ties and rope without altering the structural integrity of the standard equipment. Further, retrofitting the existing standard equipment is straightforward; as a result, there is not need to invest heavily in new equipment, so implementation costs are nominal. Although the embodiments above have been described in relation to a single safety hook, it should be clear to the skilled person that the safety system of the present invention could also be used with a two or more hooks so that the warning means generate a signal to indicate that all the two or more hooks are disconnected, connected or that a load greater than a predetermined value is being applied to one of the two or more hooks.

Moreover, it should also be apparent that the invention can be used with different types of hooks such as karabiners, ascenders, descenders, fall arresters, crane hooks and scaffold hooks.

In addition, it should be clear that the notifications generated by the warning means may be lights of different colours, lights flashing in different patterns, audible alarms, a combination of coloured/flashing lights and an audible alarm or any other suitable means to attract attention.

Further, it should also be apparent that although processing and warning means according to the invention have been described as being separate from the load detection sensor, it would possible to integrate both of these into a safety hook comprising a load detection sensor according to the present invention, for example by mounting them in the rigid plate described in relation to the second and third embodiments or by adhering them to the layer of shrinkable polymer plastics material described in relation to the first embodiment once heat has been applied to it.

Moreover, it should be clear that the beacon and control unit could be powered with any suitable power source other than batteries, such as: a kinetic power generator/microgenerator or a solar power cell.

Although the safety system of the present invention has been described in relation to its use in the construction industry, it should be clear to the skilled person that the safety system could also be used for scaffolding, climbing, abseiling, sailing, rope rescue, industrial rope work, window cleaning and any other activity in which safety belts and or harnesses are necessary.

What is claimed is:

1. A method of providing a safety system, comprising the steps of:
(a) providing a first rope or lanyard to which a first attached safety hook is attached;
(b) retrofitting a first load detection sensor to the first safety hook without altering the structural integrity of the first safety hook by mounting the first load detection sensor on or shrink wrapped on the first safety hook;
(c) detecting a load by the first load detection sensor;
(d) generating a load status signal by the first load detection sensor in response to the detecting of the load; and
(e) via a transmitter arranged to receive the load status signal from the first load detection sensor, receiving the load status signal from the first load detection sensor and transmitting the load status signal therefrom.

2. The method of claim 1, further comprising the steps of:
determining, at a first time, if the load status signal is greater than 0 N; and
if no load is detected at the first time, generating a signal that the first safety hook is not hooked.

3. The method of claim 1, further comprising the steps of:
determining, at a second time, if the load status signal is less than 5 N; and
if a load is detected at the second time that is less than 5 N, generating a signal that the first safety hook is hooked.

4. The method of claim 1, further comprising the steps of:
determining, at a third time, if the load status is greater than 5 N; and
if a load is detected at the third time that is greater than 5 N, generating a signal indicating that a user associated with the first safety hook has fallen.

5. The method of claim 2, further comprising the steps of:
determining, at a second time, if the load status signal is less than 5 N; and
if a load is detected at the second time that is less than 5 N, generating a signal that the first safety hook is hooked.

6. The method of claim 5, further comprising the steps of:
determining, at a third time, if the load status is greater than 5 N; and
if a load is detected at the third time that is greater than 5 N, generating a signal indicating that a user associated with the first safety hook has fallen.

7. The method of claim 1, further comprising the steps of:
(f) providing a second rope or lanyard to which a second attached safety hook is attached;
(g) retrofitting a second load detection sensor to the second safety hook without altering the structural integrity of the second safety hook by mounting the second load detection sensor on or shrink wrapped on the second safety hook;
(h) detecting a load by the second load detection sensor;
(i) generating a load status signal by the second load detection sensor in response to the detecting of the load; and
(j) via a transmitter arranged to receive the load status signal from the second load detection sensor, receiving the load status signal from the second load detection sensor and transmitting the load status signal therefrom.

8. The method of claim 7, further comprising the steps of:
determining, at a first time, if the load status signal is greater than 0 N; and
if no load is detected at the first time, generating a signal that the second safety hook is not hooked.

9. The method of claim 7, further comprising the steps of:
determining, at a second time, if the load status signal is less than 5 N; and
if a load is detected at the second time that is less than 5 N, generating a signal that the second safety hook is hooked.

10. The method of claim 7, further comprising the steps of:
determining, at a third time, if the load status is greater than 5 N; and
if a load is detected at the third time that is greater than 5 N, generating a signal indicating that a user associated with the second safety hook has fallen.

11. The method of claim 8, further comprising the steps of:
determining, at a second time, if the load status signal is less than 5 N; and
if a load is detected at the second time that is less than 5 N, generating a signal that the second safety hook is hooked.

12. The method of claim 11, further comprising the steps of:
determining, at a third time, if the load status is greater than 5 N; and
if a load is detected at the third time that is greater than 5 N, generating a signal indicating that a user associated with the second safety hook has fallen.

13. A method of operating a safety system comprising (a) a first rope or lanyard, (b) a first safety hook attached to the first rope or lanyard, (c) a first load detection sensor retrofit on the first safety hook without altering the structural integrity of the first safety hook by being mounted on or shrink wrapped on the first safety hook, wherein the first load detection sensor generates a load status signal, and (d) a first transmitter arranged to receive the load status signal from the first load detection sensor and to transmit the load status signal therefrom, the method comprising:
determining, at a first time, if the load status signal is greater than 0 N;
if no load is detected at the first time, generating a signal that first safety hook is not hooked;
determining, at a second time, if the load status signal is less than 5 N;
if a load is detected at the second time that is less than 5 N, generating a signal that the first safety is hooked;
determining, at a third time, if the load status is greater than 5 N; and
if a load is detected at the third time that is greater than 5 N, generating a signal indicating that a user associated with the first safety hook has fallen.

14. A method of claim 13, further comprising (e) a second rope or lanyard, (f) a second safety hook attached to the second rope or lanyard, (g) a second load detection sensor retrofit on the second safety hook without altering the structural integrity of the second safety hook by being mounted on or shrink wrapped on the second safety hook, wherein the second load detection sensor generates a load status signal, and (h) a second transmitter arranged to receive the load status signal from the second load detection sensor and to transmit the load status signal therefrom, the method further comprising:
determining, at a first time, if the load status signal is greater than 0 N;
if no load is detected at the first time, generating a signal that second safety hook is not hooked;
determining, at a second time, if the load status signal is less than 5 N;
if a load is detected at the second time that is less than 5 N, generating a signal that the second safety is hooked;
determining, at a third time, if the load status is greater than 5 N; and
if a load is detected at the third time that is greater than 5 N, generating a signal indicating that a user associated with the second safety hook has fallen.
